(19) United States
(12) Patent Application Publication
(10) Pub. No.: US 2015/0010342 A1
(43) Pub. Date: Jan. 8, 2015

(54) Pin Joint For An Eccentric Screw Pump

(71) Applicants: Michael Groth, Neuoetting (DE); Reinhard Denk, Muehldorf (DE)

(72) Inventors: Michael Groth, Neuoetting (DE); Reinhard Denk, Muehldorf (DE)

(21) Appl. No.: 14/498,382

(22) Filed: Sep. 26, 2014

Related U.S. Application Data
(63) Continuation of application No. PCT/DE2013/100108, filed on Mar. 21, 2013.

(30) Foreign Application Priority Data
Mar. 27, 2012 (DE) 102012006025.4

(51) Int. Cl. F16C 11/04

(52) U.S. Cl. CPC F16C 11/04
USPC 403/154

(57) ABSTRACT

A pin joint for eccentric screw pumps. The special design of the inner joint head of the pin joint, with its bores for the flushing liquid and the length of the joint pin, makes it possible also to carry out cleaning using the CIP method.

### FIELD OF THE INVENTION

The invention relates to an open pin joint and a method for operating this pin joint for eccentric screw pumps in the hygiene sector. The joint has an inner and an outer joint head, wherein each joint head comprises at least one diametrical bore, which is penetrated by a pin which is provided at both ends with a cap in each case. The inner spherical joint head has a convex bore course in the region of the pin.

### BACKGROUND OF THE INVENTION

A pin joint for an eccentric screw pump emerges from DE 10 2006 058 166 A1. The pin joint is surrounded by a collar in order to keep the lubricant in the region of the joint. When the lubricant is replaced, the interior of the joints can also comprise a central lubricant channel per joint in order to remove the lubricant. Since the joint does not have to be completely cleaned for the replacement of lubricant, this design of the joint may be sufficient.

DE 101 16 641 A1 discloses a pin joint with a part of a drive shaft and a part of a coupling rod. An end region of the drive shaft is provided with a coaxial plug-in socket. The coupling pin of the coupling rod projects into this plug-in socket. For the cleaning of the interior of the plug-in socket, the wall of the latter comprises two diametrical flushing bores.

The problem of the present invention is to design a pin joint which can also be used for the hygiene sector, wherein attention is focused in particular on the difficult, but necessary cleaning of the bore of the inner joint head which accommodates a joint pin.

### SUMMARY OF THE INVENTION

The inventive technical solution to the problem is achieved by the features of the invention.

According to a first embodiment of the pin joint according to the invention, a spherical joint head comprises at its end face at least two channels which are disposed eccentrically with respect to the longitudinal axis.

In a preferred embodiment of the pin joint, the channels are inclined at an angle of 10° to 30° outwards from the longitudinal axis of the drive shaft in the direction of the outer side of the pin joint. The cleaning liquid thus flows in the paraxial region of the drive shaft into the inner joint head and flows radially offset to the inlet at the inner side of the inner joint head. The cleaning of the joint or joints accordingly takes place radially from the longitudinal axis of the jointed shaft from the inner joint head to the outer joint head.

In order that the flushing liquid passes into every region of the gap between the pin and the inner and outer joint head, the pin extends in its length by at least 5% of the cap diameter beyond the external diameter of the outer joint heads. The effect of lengthening the pin is that the pin can move radially in the joint and a relative motion component thus results in the joint gaps, which leads to circulation of the cleaning liquid. The cross-section of the pin/pins is reduced compared to the cross-section of the bores.

For the further improvement of the flow of the cleaning liquid, the channels for the cleaning liquid are disposed in such a way that they each emerge in the case of the inner joint head in the region of the pin, in which region its bore diverges from the longitudinal axis of the jointed shaft radially in the direction of the respective outer joint head.

The cleaning of the open pin joint according to the invention takes place during the rotation of the joint or joints, wherein the flushing liquid exerts a radially acting pressure on the flushing liquid on account of the eccentric wobbling motion of the joint. The wobbling motion causes a constant reduction and increase in the cylindrical annular space between the pin and the bore of the inner joint head. Each joint head connection thus represents its own pump for the flushing liquid. Since the flushing liquid is introduced eccentrically into the joint, where the gap between the joint head and the pin is at its smallest, the quantity of flushing liquid corresponding to the pin joint according to the invention is much greater per unit of time. The flushing liquid is displaced from the inner region into the outer region of the pin joint.

The invention is explained below with the aid of diagrammatic drawings.

In the figures:

### BRIEF DESCRIPTION OF THE DRAWINGS

FIG. 1 shows an eccentric screw pump with two open pin joints.

FIG. 2 shows a detail with a pin joint with parallel flushing liquid bores.

FIG. 3 shows a detail with a pin joint with flushing liquid bores disposed inclined.

FIG. 4 shows a plan view of the pressure flange of the eccentric screw pump.

### DETAILED DESCRIPTION OF THE INVENTION

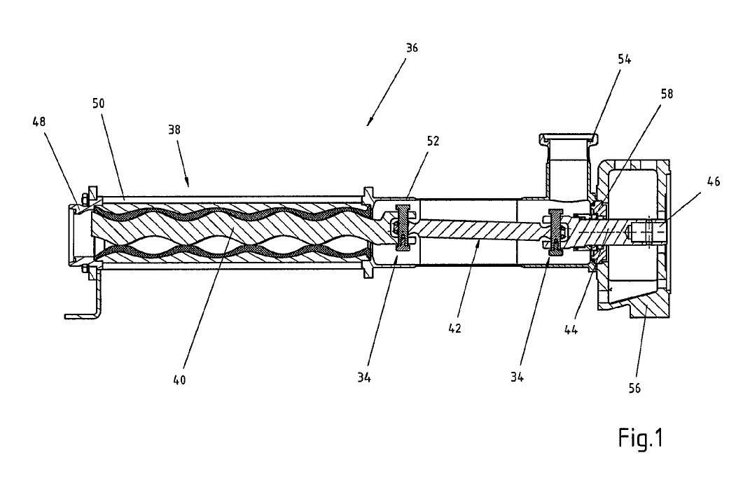

FIG. 1 shows an eccentric screw pump 36 with a stator 38 in which a rotor 40 is located. Rotor 40 moves eccentrically in stator 38 and, for this purpose, is connected via a jointed shaft 42 to an intermediate shaft 44, and the latter to drive shaft 46 of a drive (not represented). A pressure flange 48 sits on one end of the stator, said pressure flange being clamped with pump housing 52 by means of screws 50. Suction port 54 sits on the upper side of pump housing 52, via which suction port the medium to be conveyed enters into pump housing 52.

Suction port 54 is located in the immediate vicinity of sealing housing 56 and seal 58, which can be embodied as a slip-ring seal. Suction port 54 is disposed tangential to or on pump housing 52. Seal 58 sits on intermediate shaft 44, which is rigidly connected to drive shaft 46. Jointed shaft 42 is connected non-rotatably by joints, here pin joints 34, both to intermediate shaft 42 and also to rotor 40.

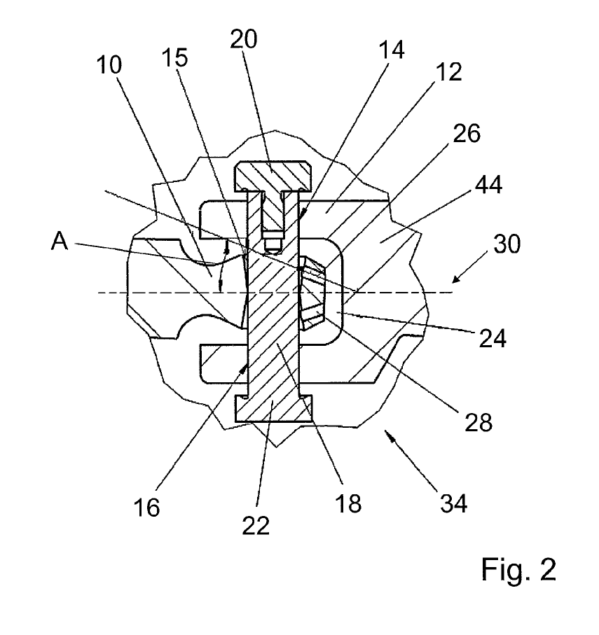

A variant of a pin joint 34 is represented in FIG. 2. The example shows an inner joint head 10 and an outer joint head 12. Both joint heads 10, 12 are provided with bores 14, 15, 16, through which a pin 18 extends. The pin is constituted cylindrical between its caps 20, 22. Bore 15, on the other hand, is rounded inwardly in a convex manner in the region of the pin, so that the course of the bore diverges from inside outwards, i.e. widens. This widening of bore 15 gives pin 15 the necessary freedom of movement with respect to inner joint head 10. When pin joint 34 rotates, inner joint head 10 performs a wobbling motion which arises due to eccentrically rotating rotor 40, which transmits this motion via the jointed shaft to the two pin joints 34.

Two channels 26, 28 begin at end face 24 of inner joint head 10, said channels extending into diametrical bore 15. Flushing liquid passes through these bores from the pump housing in a targeted manner into bore 15 and here removes residues of the conveyed medium. Since the bores do not run centrally along longitudinal axis 30 of intermediate shaft 44, but at an angle A of 10° to 30°, this radially directed flow assists removal from or cleaning of bore 15. On account of the wobbling motion of joint head 10, the radially widening inner faces of bore 15 push the flushing liquid out of the internal region of joint head 10. The channels in head end 60 of the joint head emerge, at a distance from longitudinal axis 30, in the region of bore 15 in the already diverging surface region.

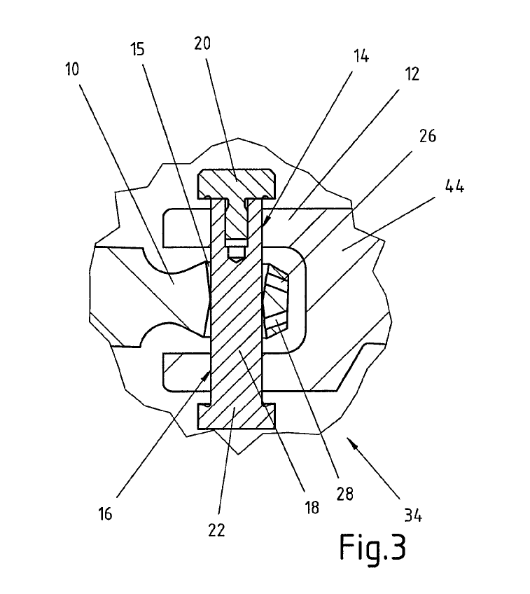

A further possibility for cleaning a pin joint with flushing liquid is represented in FIG. 3. Here too, joint head 10 comprises a diametrically running bore 15 and, in this example of embodiment too, bore 15 widens from longitudinal axis 30 radially in the direction towards outer joint head 12. Bores 26, 28 run parallel to longitudinal axis 30 of joint head 10 and intermediate shaft 44. Channels 26, 28 emerge inside bore 15 in the joint head 10 in the region of bore 15 which widens radially in the direction towards outer joint head 12. The circulation of the flushing liquid in the region of diametrical bore 15 is achieved by the motion of pin 18. Pin 18 comprises two caps 20, 22 which, depending on the position of pin joint 34, lie adjacent to the respective upper side of pin joint 34. As a result of the relative motion of pin 18 along its longitudinal axis, the gaps in bores 14, 16 are also flushed. Cap 20 is part of a screw which is part of pin 18.

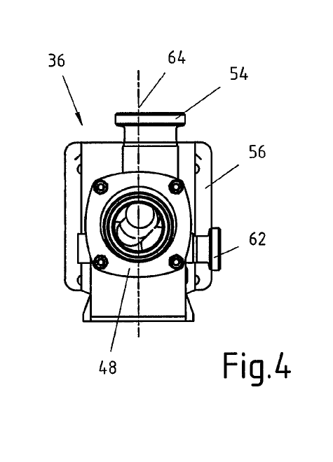

A plan view of pressure flange 48 of the eccentric screw pump 36 is reproduced in FIG. 4. Tangentially disposed suction port 54 in the pump housing can also be seen from this view. As a result of this tangential arrangement of the suction port, the flushing liquid acquires, upon the entry into the pump housing, also referred to as the pump inlet housing, a swirling flow component and therefore, already in the inlet region, flushes the inner side of the pump housing up to outlet 62 along a self-generating helical flow.

### LIST OF REFERENCE NUMBERS

10 joint head

12 joint head

14 bore

15 bore

16 bore

18 pin

20 cap

22 cap

24 end face

26 channel

28 channel

30 longitudinal axis

34 pin joint

36 eccentric screw pump

38 stator

40 rotor

42 jointed shaft

44 intermediate shaft

46 drive shaft

48 pressure flange

50 screws

52 pump housing

54 suction port

56 sealing housing

58 seal

62 outlet

64 axis

1. An open pin joint for an eccentric screw pump in the hygiene sector, with an inner and an outer joint head, wherein each joint head comprises at least one diametrical bore, which is penetrated by a pin which is provided at both ends with a cap in each case, characterised in that the inner joint head is provided at its end face with at least two channels, which are disposed eccentrically with respect to the longitudinal axis of the jointed shaft, wherein the channels each extend at an angle A of 10° to 30° from the longitudinal axis of the drive shaft in the direction of the outer side of the pin joint.

2. The open pin joint according to claim 1, wherein the pin extends by at least 5% of the cross-section of caps beyond the outer joint heads of the pin joint.

3. The open pin joint according to claim 1, wherein the cross-section of the pin is smaller than the diametrical bores of the joint heads and is therefore mobile in the bore.

4. The open pin joint according to claim 1, wherein the channels emerge into a region between the inner joint head and the pin in which surfaces of the inner joint head diverge in the direction of the outer joint head.
